(19) United States
(12) Patent Application Publication
(10) Pub. No.: US 2007/0202304 A1
(43) Pub. Date: Aug. 30, 2007

(54) Nanoparticle colloid, method for its production and its use in the growth of carbon nanotubes

(75) Inventors: Vladimir Golovko, Cambridge (GB); Brian F.G. Johnson, Cambridge (GB); John Robertson, Harston (GB); Mirco Cantoro, Cambridge (GB); Angel Berenguer, Alicante (ES); Wilhelm Huck, Comberton (GB); Hongwei Li, Cambridge (GB); Zongqiang Yang, Cambridge (GB)

Correspondence Address: NIXON & VANDERHYE, PC, 901 NORTH GLEBE ROAD, 11TH FLOOR, ARLINGTON, VA, 22203, US

(73) Assignee: Cambridge University Technical Services Limited,, Cambridge (GB)

(21) Appl. No.: 11/362,261

(22) Filed: Feb. 27, 2006

(51) Int. Cl. B44C 1/17

(52) U.S. Cl. 428/195.1

(57) ABSTRACT

A method for producing a colloid of metallic nanoparticles including the steps of: providing metal ions in solution; providing a stabilizing agent; and reducing said metal ions in the presence of said stabilizing agent, so that metallic nanoparticles are formed with a surrounding layer of said stabilizing agent, wherein the reduction step is carried out at a temperature of not less than 20° C. and not more than 150° C. The metallic nanoparticles are formed of a mixture of transition metal and noble metal, such as Ni—Pd. The resultant nanoparticles have a high stability in terms of size and chemical degradation and so can be stored for long periods. They are therefore particularly suited for forming patterned nanoparticle arrays on a substrate by nanocontact printing for the subsequent formation of a corresponding array of carbon nanotubes or nanofibers via plasma enhanced CVD.

### BACKGROUND TO THE INVENTION

1. Field of the Invention

The present invention relates to metallic nanoparticles, methods for their fabrication and their uses. Such nanoparticles have particular, but not exclusive, application to the growth of carbon nanotubes and carbon nanofibers.

2. Related Art

Many prior documents discuss the formation of metallic nanoparticles via different synthesis routes.

Lu et al (“Polymer-protected Ni/Pd bimetallic nano-clusters: preparation, characterization and catalysis for hydrogenation of nitrobenzene”, J. Phys. Chem. B 1999, 103, 9673-9682) disclose the reduction of metal ions in alcohol (glycol) in the presence of PVP to form stabilized bimetallic nanoclusters. The metal ion reduction step took place with stirring and refluxing at 198° C. under a flow of nitrogen. Ni/Pd nanoclusters were reported to be formed, having an average particle size of 1.9 nm with a standard deviation of 0.27 nm. It is also reported in this document that dilute colloidal dispersions of the nanoclusters (0.1 mM) in a reductive medium such as glycol showed neither precipitates nor catalytic inferiority even after storage under nitrogen for six months. Roucoux et al (“Reduced transition metal colloids: a novel family of reusable catalysts?”, Chem. Rev. 2002, 102, 3757-3778) reviewed chemical processes for producing stable colloids of transition metal nanoclusters, including bimetallic nanoclusters. The processes reviewed were:
(a) chemical reduction of transition metal salts (e.g. reduced in refluxing alcohol; using hydrogen or carbon monoxide; using hydrides or other reducing agents)
(b) thermal, photochemical or sonochemical decomposition
(c) ligand reduction and displacement from organometallics
(d) metal vapour synthesis
(e) electrochemical reduction

The authors also review modes for stabilization of the colloid. They suggest four distinct stabilization procedures:
(i) electrostatic stabilization by surface adsorbed anions
(ii) steric stabilization by the presence of bulky groups (e.g. polymers or oligomers adsorbed at the surface of the nanoclusters)
(iii) combination of electrostatic and steric stabilization by electrosteric stabilization provided by surfactants
(iv) stabilization with a ligand

Son et al (“Designed synthesis of atom-economical Pd/Ni bimetallic nanparticle-based catalysts for Sonogashira coupling reactions”, J. Am. Chem. Soc. 2004, 126, 5026-5027) discuss the thermal decomposition route for forming bimetallic nanoparticles of Pd/Ni, generating the particles from metal-surfactant complexes at between 205° C. and 235° C.

Lisiecki (“Size, shape and structural control of metallic nanocrystals”, J. Phys. Chem. B 2005,109, 12231-12244) sets out a detailed description of the control of the size and shape of copper nanoparticles and cobalt nanoparticles. The nanoparticles are formed using a reverse micelle process in which surfactant (based on di(2-ethylhexyl)sulfosuccinate, or AOT), having a polar hydrophilic head and a hydrophobic hydrocarbon chain, allows the formation of water-in-oil droplets. In turn, this allows the formation of nanoparticles, by mixing two micellar solutions containing the required reactants. For the formation of cobalt nanoparticles, the reducing agent in sodium tetrahydroborate. For the formation of copper nanoparticles, the reducing agent is hydrazine.

Other prior documents discuss the formation of carbon nanotubes using the catalytic activity of metallic nanoparticles.

Cheung et al (“Diameter-controlled synthesis of carbon nanotubes”, J. Phys. Chem. B 2002,106, 2429-2433) disclose the growth of carbon nanotubes by chemical vapour deposition (CVD) on iron nanoparticles. The iron nanoparticles (described as nanoclusters) were produced by the thermal decomposition of iron pentacarbonyl (Fe(CO)₅) in a mixture of dioctyl ether and oleic acid, lauric acid or octanoic acid by refluxing at 286° C. under nitrogen for 1-3 hours. The resultant iron nanoclusters had different average diameters depending on the synthesis route. The iron nanoclusters were deposited onto substrates (oxidised silicon) in order to catalyse the growth of carbon nanotubes. CVD growth of carbon nanotubes was achieved at 800-1000° C. Cheung et al found that the diameter of the resultant carbon nanotubes was dependent on the diameter of the iron nanoparticles. The oleic acid (C18), lauric acid (C12) or octanoic acid (C8) have different chain lengths and function as capping ligands around the nanoclusters. In general, the growth of smaller diameter nanoclusters is promoted by the use of longer chain-length capping ligands. Particularly for the smallest diameter nanoclusters, the resultant carbon nanotube diameter is closely related to the diameter of the nanoclusters.

Zaretskiy et al (“Growth of carbon nanotubes from Co nanoparticles and C₂H₂ by thermal chemical vapor deposition”, Chemical Physics Letters 372 (2003) 300-305) disclose the growth of carbon nanotubes from 5 nm diameter Co nanoparticles using acetylene as the feedstock gas in the thermal CVD process. The Co nanoparticles were synthesised using a thermal decomposition process in which the resultant Co particles are coated in AOT (bis(2-ethylehexyl)sulfosuccinate) and are dispersed as a colloid in toluene. Three average particle sizes of Co were achieved: 2, 5 and 8 nm. The nanoparticles were distributed on a silicon wafer by spin coating and the carbon nanotubes were grown at 1050-1150 K. However, the resultant carbon nanotubes were non-uniform.

Ago et al (“Ink-jet printing of nanoparticle catalyst for site-selective carbon nanotube growth”, Applied Physics Letters Vol. 82, No. 5 (2003) 811-813) disclose a mode for growing multiwalled carbon nanotubes from a pattern of Co nanoparticles deposited on a substrate by ink jet printing. A colloid of Co nanoparticles was formed by a reverse micelle method in which a nanoscale water pool containing Co ions is stabilised by a didecyldimethylammonium bromide surfactant and chemically reduced with sodium borohydride. CVD synthesis of carbon nanotubes was carried out at 600-900° C. using acetylene gas as carbon feedstock. The reported Co nanoparticles have diameters of 3.4-7.0 nm and a mean diameter of 4.7 nm. The authors note that the Co nanoparticles become less stable after purification and concentration of the Co nanoparticles, possibly due to a removal of some of the surfactant surround the Co nanoparticles during the purification and concentration process.

Wang et al (“Bimetallic catalysts for the efficient growth of SWNTs on surfaces”, Chem. Mater. (2004), 16(5); 799-805) discuss the production of bimetallic nanoparticles of Fe/Ru and Fe/Pt using chemical reduction under microwave irradiation. The nanoparticles were stabilised using PVP (poly(N-vinyl-2-pyrrolidone). The nanoparticles had diameters distributed in the range 0.5-2.7 nm. A 200% increase in single wall nanotube (SWNT) yield is claimed for these Fe/Ru and Fe/Pt nanoparticles compared with comparable diameter mono-metallic nanoparticles.

Cantoro et al (“Wet catalyst assisted growth of carbon nanofibers on complex three-dimensional substrates”, Diamond & Related Materials 14 (2005) 733-738) disclose the formation of carbon nanofibers from different organo-metallic catalysts by thermal and plasma-enhanced CVD. Nickel nanoparticles were produced from a nickel formate solution on a nickel foam substrate. Cobalt nanoparticles were produced via an inverse micelle method and coated onto carbon cloth for carbon nanofiber growth.

There are several known routes for patterning or positioning carbon nanotubes on a surface. These generally are either aligning already-grown carbon nanotubes by some solution-based post-processing route or by pre-patterning a catalyst on the surface and then growing nanotubes by chemical vapour deposition (see, for example, Merkulov et at (2000, Appl. Phys. Lett. 76, 3555)). Alignment after growth generally does not provide a strong attachment between the surface and the carbon nanotubes, and so is unsuitable for applications such as display technology. For catalyst pre-patterning, electron-beam lithography can create patterns with a precision of a few nanometres and is suitable for high value products (see, for example, Teo et al (2003 Nanotechnology 14 204)). However, the serial electron-beam writing process is not suitable for large-area, low cost applications.

Kind et al (“Printing gel-like catalysts for the directed growth of multiwall nanotubes”, Langmuir 2000, 16, 6877-6883) disclose a method of microcontact printing of a Fe(III) salt gel-like catalyst precursor ink from a patterned stamp onto a substrate. The ink was applied to a substrate using a patterned stamp. Using the techniques disclosed in this document, printed features of minimum lateral dimensions of 10 μm are disclosed, and carbon nanotubes grew from the patterned areas. The patterned stamp is formed from poly(dimethylsiloxane) (PDMS) cured on a master prepared via photolithography. The surface of the stamp was treated using an oxygen plasma prior to inking to render the stamp surface hydrophilic.

### SUMMARY OF THE INVENTION

The present inventors have realised that there are several important factors in the production of suitable nanoparticles, particularly for catalysing the growth of carbon nanotubes or nanofibers. One such factor is that the nanoparticles should be stable, in terms of their composition (e.g. resistance to oxidation in air during storage) and in terms of their resistance to sintering, agglomeration or flocculation. Another such factor is that the nanoparticles, when produced, should have a small, sharply-defined particle size distribution. Accordingly, it is an object of the present invention to provide nanoparticles having catalytic activity, such particles being resistant to oxidation in air during storage. It is a further object of the present invention to provide nanoparticles having a small, sharply-defined particle size distribution.

In a first aspect, the present invention provides a method for producing a colloid of metallic nanoparticles including the steps of:
providing metal ions in solution;
providing a stabilizing agent; and
reducing said metal ions in the presence of said stabilizing agent, so that metallic nanoparticles are formed with a surrounding layer of said stabilizing agent,
   wherein the reduction step is carried out at a temperature of not less than 20° C. and not more than 150° C.

Without limiting the invention thereto, the inventors consider that the use of mild conditions during the reduction step allows the formation of metallic nanoparticles having a small size with a narrow distribution of sizes. These metallic nanoparticles are also stable in terms of size and can also be stable against chemical degradation, e.g. oxidation. This makes the metallic nanoparticles particularly suitable as catalysts, for example for the growth of carbon nanotubes.

Preferably, the reduction step is carried out at a temperature of not less than 50° C. More preferably, the reduction step is carried out at a temperature of not less than 75° C. Preferably, the reduction step is carried out at a temperature of not more than 140° C.

Preferably, the average particle size of the metallic nanoparticles is between 1 nm and 6 nm. More preferably, the average particle size is 5 nm or less, and most preferably 4 nm or less. Preferably, the standard deviation of the particle size of the metallic nanoparticles is 2 nm or less. More preferably, the standard deviation is 1.5 or less, 1 nm or less, 0.8 nm or less, or 0.6 nm or less.

Preferably, the metallic nanoparticles are multimetallic nanoparticles. For example, each metallic nanoparticle may include at least one transition metal (preferably a first row transition metal) and at least one noble metal. Preferably, the metallic nanoparticies are formed from at least one metal selected from palladium, nickel, iron and cobalt. Most preferably, the metallic nanoparticles are Ni—Pd bimetallic particles. The Ni—Pd metallic nanoparticles may have a molar ratio of Ni:Pd of 1:1 or less. Alternatively, the Ni—Pd metallic nanoparticles may have a molar ratio of Ni:Pd of 1:2 or less.

Preferably, the reduction of the metal ions is carried out in a polyol. Most preferably, the reduction of the metal ions is carried out without refluxing. However, it is possible for the mixture containing the metal ions to include other solvents. It is not excluded that the reduction step may take place at a temperature at or above the boiling point of those other solvents. The method may further include the steps of adding excess ketone to flocculate the nanoparticles, thereby removing excess of the stabilizing agent from the nanoparticles, and removing a resultant supernatant liquid phase. This may be followed by the additional step of adding an alcohol after removal of the mixture of the supernatant liquid phase, in order to re-disperse the nanoparticles.

It is considered that first row transition metals are particularly active as catalysts for carbon nanotube growth.

Preferably, the stabilizing agent is a polymer, molecules of said polymer interacting with the surfaces of said nanoparticles by adsorption. Alternatively, the stabilizing agent may be a surfactant.

In a second aspect, the present invention provides a patterned array of carbon nanotubes or nanofibers on a substrate, wherein metallic nanoparticles are disposed at an extremity of said nanotubes, said metallic nanoparticles being formed of a mixture of a transition metal and a noble metal.

Preferably, the metallic nanoparticles are disposed at the tips of said nanotubes or nanofibers.

Preferably, the metallic nanoparticles are the metallic nanoparticles set out above with respect to the first aspect, including any preferred or optional feature thereof, except without the layer of stabilising agent.

Preferably, the carbon nanotubes or nanofibers are aligned upstanding from the substrate. Most preferably, the nanotubes or nanofibres are bonded to the substrate. The array may be patterned so that gaps of at least twice the height of the carbon nanotubes or nanofibers are formed between adjacent nanotubes or nanofibers or groups of nanotubes or nanofibers.

In a third aspect, the present invention provides a method of producing an array of carbon nanotubes on a substrate including the steps:
applying nanoparticles onto the substrate, said nanoparticles being formed of a mixture of a transition metal and a noble metal growing carbon nanotubes via chemical vapour deposition, in which growth the nanoparticles act as catalysts.

The nanoparticles may be as set out above with respect to the first aspect, including any preferred or optional feature thereof.

Preferably the substrate is selected from: a flat substrate and a three-dimensional porous substrate.

Preferably the chemical vapour deposition is plasma-enhanced chemical vapour deposition.

The nanoparticles applied to the substrate may have a surrounding layer of stabilizing agent, in order to reduce agglomeration of the nanoparticles. Preferably, the stabilizing agent is a polymer, molecules of said polymer interacting with the surfaces of said nanoparticles by adsorption. The nanoparticles may be formed from Ni—Pd.

In a fourth aspect, the present invention provides a method of producing an array of carbon nanotubes on a substrate including the steps:
applying metallic nanoparticles onto a profiled surface of a tool;

applying a pattern of metallic nanoparticles onto the substrate by contacting the substrate with the profiled surface of said tool; and
growing carbon nanotubes via chemical vapour deposition, in which growth the metallic nanoparticles act as catalysts,
   wherein at least one feature of said pattern has a dimension of 500 nm or less.

The metallic nanoparticles may be as set out with respect to the first aspect, including any preferred or optional feature thereof.

Preferably, the profiled surface of the tool has at least one projecting feature (typically a uniformly repeating projecting feature) with a dimension of 100 nm or less. This is typically a lateral dimension. The pattern of the tool may be a series of discrete features, such as an array of peaks (for forming a pattern of dots) or a series of ridges (for forming a pattern of lines). The separation of features on the profiled surface of the tool may be 400 nm or less, or 300 nm or less, or 200 nm or less.

Preferably, the profiled surface of said tool is formed from a layer of a first material, and said layer of first material is formed on a carrier of a second material, said first material being harder than said second material.

Preferably, the metallic nanoparticles are applied to said tool as a suspension (e.g. a colloid) of nanoparticles in a carrier liquid, said nanoparticles being formed with a surrounding layer of a stabilizing agent. Preferably, the metallic nanoparticles are formed from a mixture of a transition metal and a noble metal.

### BRIEF DESCRIPTION OF THE DRAWINGS

FIG. 1 shows TEM images of particles from a Ni—Pd colloid prepared by heating at 180° C. FIG. 1B is at higher magnification than FIG. 1A.

FIG. 2 shows TEM images of particles from a Ni—Pd colloid obtained by heating at 120° C. FIG. 2B is at higher magnification than FIG. 2A and has an EDS spectrum insert.

FIG. 3 shows the particle size distribution graph for the colloid of FIG. 2.

FIG. 4 shows TEM images of particles from a Ni—Pd colloid obtained by heating at 120° C. FIG. 4B is at higher magnification than FIG. 4A and has an EDS spectrum insert.

FIG. 5 shows the particle size distribution graph for the colloid of FIG. 4.

FIG. 6 shows TEM images of particles from a Co—Pd colloid obtained by heating at 120° C. FIG. 6B is at higher magnification than FIG. 6A and has an EDS spectrum insert.

FIG. 7 shows the particle size distribution graph for the colloid of FIG. 6.

FIG. 8 shows TEM images of particles from a Fe—Pd colloid obtained by heating at 120° C. FIG. 8B is at higher magnification than FIG. 8A and has an EDS spectrum insert.

FIG. 9 shows the particle size distribution graph for the colloid of FIG. 8.

FIG. 10 shows a TEM image of particles from a Co colloid obtained by an inverse-micelle method using AOT as the stabilising agent.

FIG. 11 shows, schematically, a process for the manufacture of a nanocontact printing stamping tool and the formation of a pattern of nanoparticles on a substrate and the subsequent growth of carbon nanotubes on the substrate by PECVD.

FIG. 12 shows line and dot patterns of Co nanoparticles deposited on Si wafers by nanocontact printing. FIG. 12(a) is an AFM image of an array of lines of Co particles. FIG. 12(b) is an AFM measurement taken along the line indicated by an arrow in FIG. 12(a). FIG. 12(c) is an SEM image of a dot pattern of Co particles.

FIG. 13 shows SEM images in plan view of carbon nanotube (CNT) patterns on Si wafers. FIG. 13(a) shows CNT line pattern over a large area (grown at 300° C.). FIG. 13(b) shows an individual 100-150 nm wide CNT line (grown at 300° C.). FIG. 13(c) shows a CNT dot pattern over a large area (grown at 530° C.).

FIG. 14(a) shows a side view of line of carbon nanotubes on a Si substrate grown at 450° C. FIGS. 14(b) and (c) show perspective views of a dot pattern of CNTs grown at 640° C., at low and high magnification, respectively.

FIG. 15 shows a HRTEM image of a CNT grown on a Si wafer in a line pattern at 450° C. (scale bar 5 nm).

FIG. 16 shows SEM images of CNTs grown on a substrate using Ni—Pd nanoparticles. FIG. 16A shows a low magnification image and FIG. 16B shows a high magnification image.

### DETAILED DESCRIPTION OF THE PREFERRED EMBODIMENTS

Lu et al (“Polymer-protected Ni/Pd bimetallic nano-clusters: preparation, characterization and catalysis for hydrogenation of nitrobenzene”, J. Phys. Chem. B 1999, 103, 9673-9682), the content of which is hereby incorporated by reference in its entirety, disclose a process for producing Ni—Pd bimetallic nanoparticles in colloidal form. In this document, palladium (II) acetate and nickel (II) sulphate were used as the starting materials. The palladium (II) acetate was dissolved in dioxane (15.6 mM Pd(Ac)₂) and stirred for one day, resulting in a clear yellow solution. In a 1000 mL three-neck flask, PVP (polyvinylpyrrolidone) (4.006 g, 35.7 mmol in monomeric units, 14.3 times the total amount of metal ions in moles) and nickel (II) sulphate (NiSO4.7H₂O) were dissolved in 600 mL of glycol at 80° C. To this solution, the dioxane solution of Pd(Ac)₂ was added at 0-5° C., and pH values were adjusted to 9-11 by dropwise addition of an aqueous solution of sodium hydroxide (NaOH, 1 M). The two metal ions were mixed at designated mole ratios and the total amount of metal ions was always kept constant at 2.5 mmol. The solutions were stirred and refluxed at 198° C. for 3 hours with a nitrogen flow passing through the reaction system to take away water and organic by-products. The authors state that the colour of the mixed solution suddenly changed from clear yellow to transparent dark brown at the initial stage of the refluxing. The final colloidal dispersions appeared as transparent dark-brown homogeneous solutions. The colloids were stored under nitrogen and appeared to remain stable for up to half a year. For nanoparticles with a mole ratio of Ni:Pd of 2:3, there is an average particle diameter of 1.9 nm and a standard deviation of 0.27 nm. The minimum average particle diameter was 1.5 nm, achieved for a mole ratio of Ni:Pd of 7:3. The largest average particle diameter for bimetallic nanoparticles was 2.3 nm, achieved for a mole ratio of Ni:Pd of 1:9

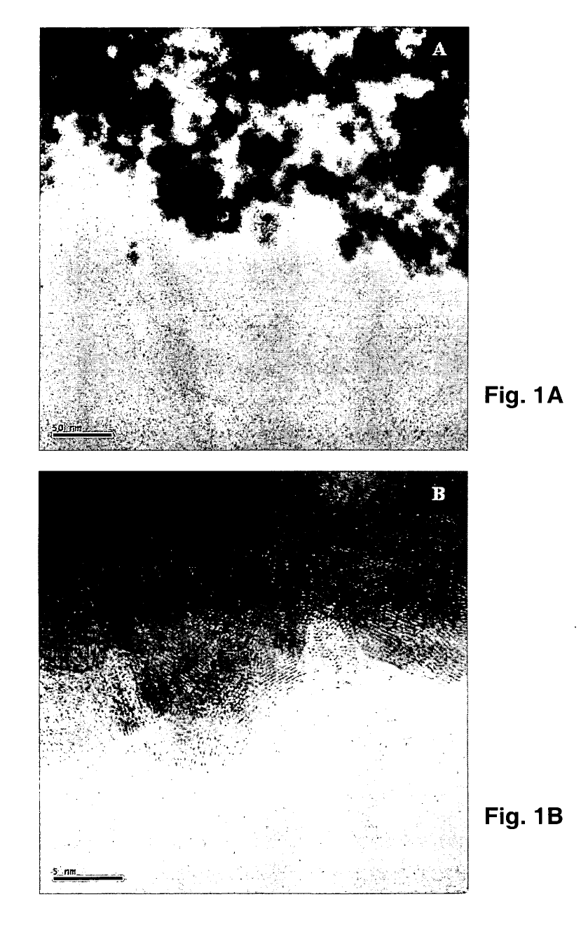

The present inventors attempted to follow the protocol set out by Lu et al in the above referenced paper. However, surprisingly, it was found that the results were not as predicted. In particular, it was found that the average particle size was significantly larger than suggested by Lu et al. FIG. 1A and FIG. 1B show transmission electron microscope (TEM) images of a particles from a Ni—Pd colloid obtained using the protocol of Lu except using a heating temperature of 180° C. It should be noted here that the heated mixture contained not only glycol (ethylene glycol) (boiling point 198° C.) but also 1,4-dioxane (boiling point 101° C.) and water (boiling point 100° C.). It is possible that azeotropic mixtures are formed in mixtures of these solvents, these azeotropic mixtures having boiling points lower than 198° C. Thus, in some regards, a heating step at 180° C. in the presence of significant quantities of 1,4-dioxane can be considered to be a refluxing step. Ni and Pd were present in the starting materials at a Ni:Pd mole ratio of 20:80. As can be seen from these images, the particles are relatively large, with an average particle size of about 10 μm. Furthermore, the particles are agglomerated together. This is the case even if the particles are sonicated. The scale bar in FIG. 1A is 50 nm and in FIG. 1B is 5 nm.

In preparing the TEM samples in the present work, the nanoparticles are cast from methanol solution, the solvent evaporated under the flow of nitrogen, onto commercially available holey carbon films supported on a copper grid, as will be well understood by the skilled person.

The present inventors realised that a problem with the Lu disclosure may be that the conditions for nanoparticle formation are too severe. These severe conditions may cause sintering of the nanoparticles, and/or particle agglomeration. Such severe conditions would therefore reduce the possibility of obtaining small, uniform particle sizes that are easily dispersed in the colloid. Accordingly, the present inventors decided to use much milder conditions for particle formation. In particular, for the polyol reduction method outlined in the Lu document, they decided to use much lower temperatures for the reduction step.

Accordingly, the present inventors carried out the same procedure as used in Lu et al (“Polymer-protected Ni/Pd bimetallic nano-clusters: preparation, characterization and catalysis for hydrogenation of nitrobenzene”, J. Phys. Chem. B 1999, 103, 9673-9682), except that the reflux of the reaction mixture was substituted by a heating step at 80-120° C.

After the heating step to form the colloid, addition of an excess of dry acetone (HPLC grade Aldrich, typically 5-10 excess by volume) to the as-made colloid results in the precipitation of a viscous black-brown residue within several hours. The liquid phase is then carefully decanted and the residue re-dispersed in freshly distilled methanol to produce a deep black-brown homogeneous solution of purified colloid. The purified colloid is stable and can be stored at room temperature. The volume of the methanol used to re-disperse the precipitated colloid determines the final concentration of the purified colloid since the synthesis and precipitation appear to be nearly quantitative.

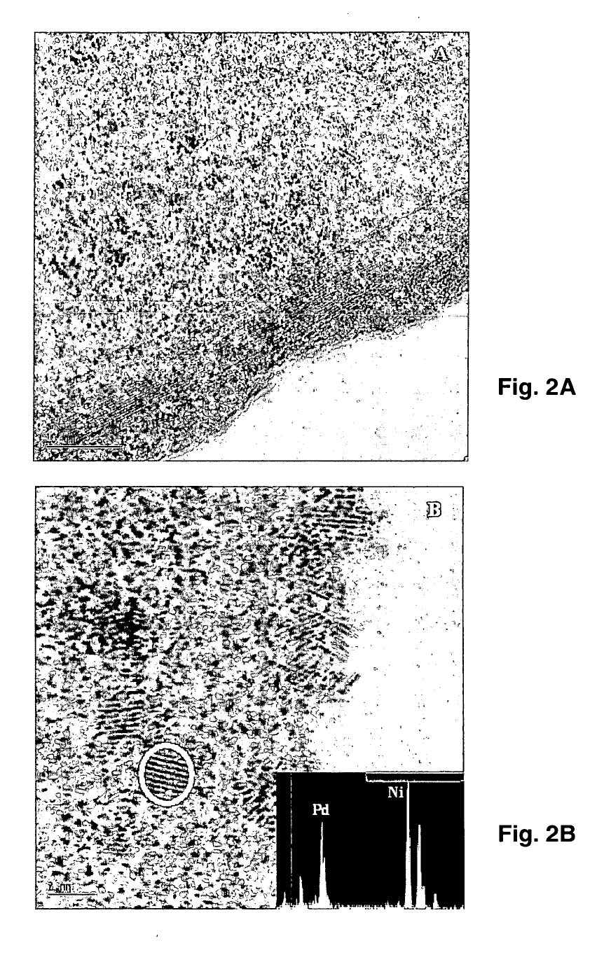

FIG. 2 shows TEM images of particles from a Ni—Pd colloid obtained by heating at 120° C. Ni and Pd were present in the starting materials at a Ni:Pd mole ratio of 70:30. The average particle size is 2.2 nm (based on a 100 particle count). In FIG. 2A, the scale bar is 10 nm in length. Note that the particles are uniformly distributed throughout the image. In FIG. 2B, the scale bar is 2 nm in length. The inset in FIG. 2B shows an EDS (energy dispersive X-ray spectrometer) spectrum of the corresponding image. One particle is circled in FIG. 2B for clarity.

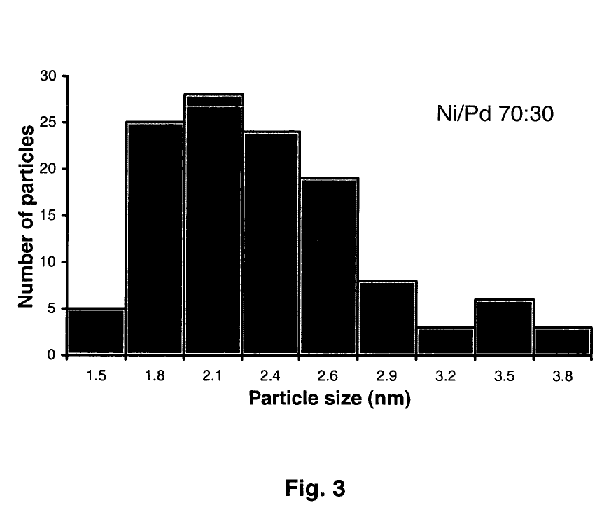

FIG. 3 shows the particle size distribution graph for the colloid of FIG. 2.

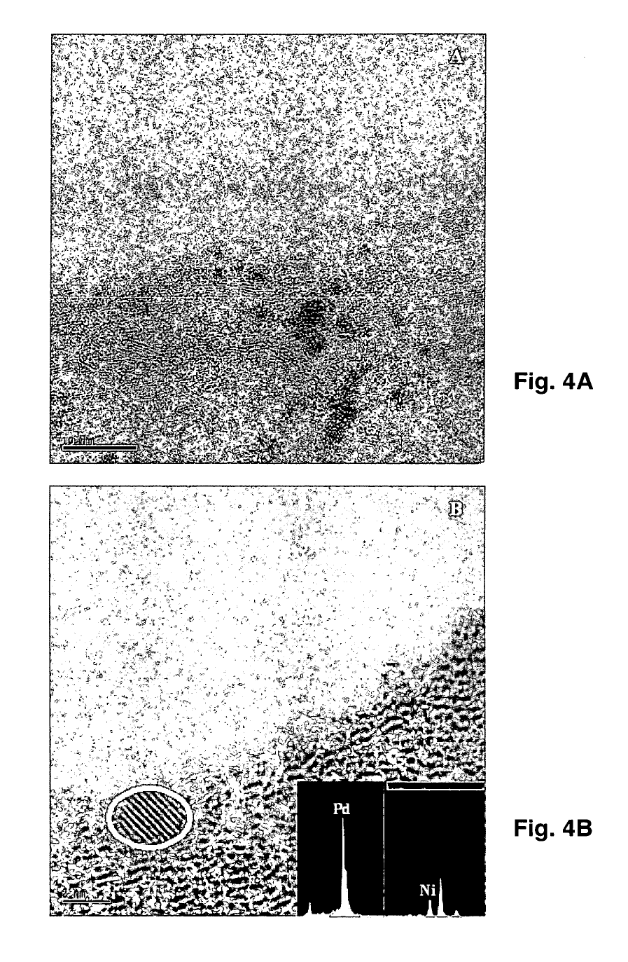

FIG. 4 shows TEM images of particles from a Ni—Pd colloid obtained by heating at 120° C. Ni and Pd were present in the starting materials at a Ni—Pd mole ratio of 20:80. The average particle size is 1.9 nm (based on a 100 particle count). In FIG. 4A, the scale bar is 10 nm in length. In FIG. 4B, the scale bar is 2 nm in length. The inset in FIG. 4B shows an EDS spectrum of the corresponding image. One particle is circled in FIG. 4B for clarity.

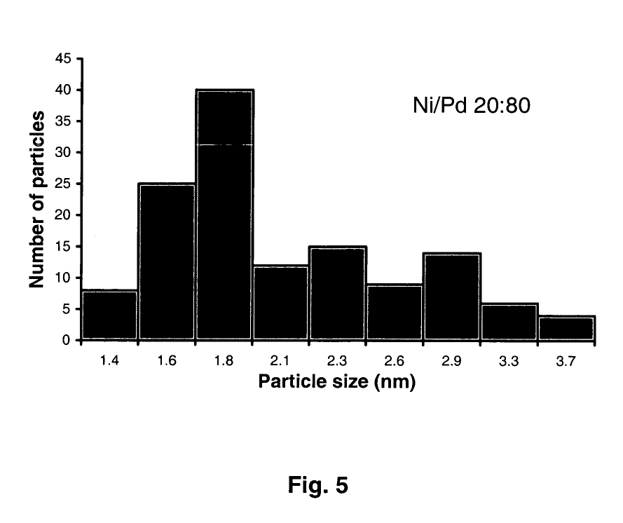

FIG. 5 shows the particle size distribution graph for the colloid of FIG. 4.

Although not intending to be limited by it, the present inventors postulate that the incorporation of an amount of a noble metal (Pd) into a nanoparticle with a transition metal (Ni) allows a synergy to prevent the particles from sintering or agglomerating. Furthermore, it is possible that the use of a lower temperature for the reduction step reduces the possibility of thermal effects overcoming the stabilising influence of the PVP shell surrounding the nanoparticles.

Accordingly, the inventors also prepared colloids using transition metals other than Ni.

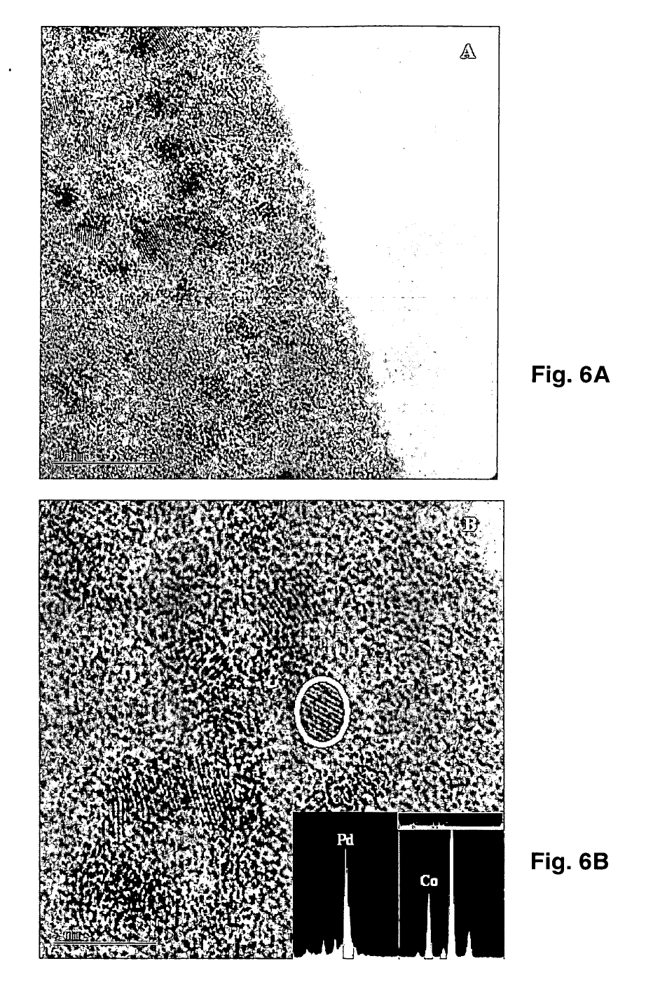

FIG. 6 shows TEM images of particles from a Co—Pd colloid obtained by heating at 120° C. A similar protocol to that used for the Ni—Pd colloids was used here. Co and Pd were present in the starting materials at a Co—Pd mole ratio of 50:50. The average particle size is 2.7 nm (based on a 100 particle count). In FIG. 6A, the scale bar is 10 nm in length. In FIG. 6B, the scale bar is 2 nm in length. The inset in FIG. 6B shows an EDS spectrum of the corresponding image. One particle is circled in FIG. 6B for clarity.

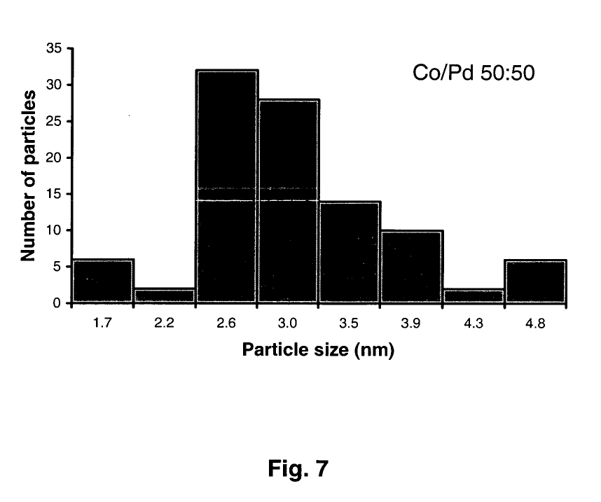

FIG. 7 shows the particle size distribution graph for the colloid of FIG. 6.

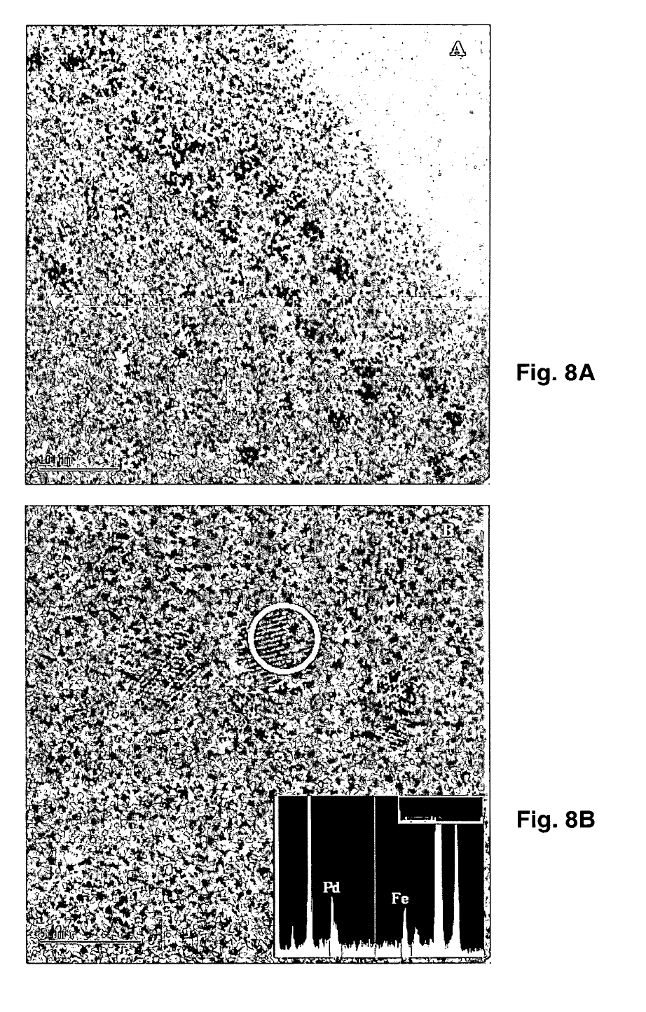

FIG. 8 shows TEM images of particles from a Fe—Pd colloid obtained by heating at 120° C. A similar protocol to that used for the Ni—Pd colloids was used here. Fe and Pd were present in the starting materials at a Fe—Pd mole ratio of 50:50. The average particle size is 2.5 nm (based on a 100 particle count). In FIG. 8A, the scale bar is 10 nm in length. In FIG. 8B, the scale bar is 2 nm in length. The inset in FIG. 8B shows an EDS spectrum of the corresponding image. One particle is circled in FIG. 8B for clarity.

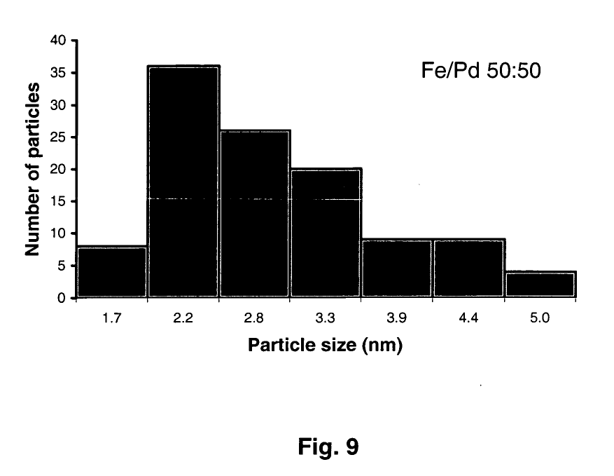

FIG. 9 shows the particle size distribution graph for the colloid of FIG. 8.

The present inventors consider that at least one reason for the improvement in the properties of the colloid is due to the use of mild conditions during the reduction step in the formation of the nanoparticles. It is envisaged that the reduction step could be carried out as high as 150° C., with a corresponding change (reduction) in the time for the reduction step. However, the reduction step could also be carried out at even milder conditions, possibly as low as room temperature (20° C.). Such a mild reduction step may take a significantly longer time than a reduction step at 80-120° C., and so may not be preferred for that reason.

The present inventors also consider that alternative heating methods would also be appropriate for the reduction step. In particular, microwave heating would be appropriate. Given this disclosure, the skilled person will readily understand how a suitable microwave heating reduction step would be implemented.

The present inventors have demonstrated that it is possible to prepare Co nanoparticles in a colloid, these Co nanoparticles being suited as a catalyst for carbon nanotube growth by plasma enhanced CVD.

In a typical preparation of a Co colloid, 6 g AOT (dioctyl sulfosuccinate, sodium salt, 98% Aldrich) is dissolved in 50 ml of 2,2,4-trimethyl pentane or iso-octane (99.7+%, HPLC grade, Aldrich) deoxygenated by bubbling of Ar for several hours in a Schlenk tube under Ar. 26 ml of this mixture is placed in a separate Schlenk tube under Ar and 1.2 ml of a solution of 227 mg NaBH₄ (98%, Lancaster) in 10 ml of distilled water is added. The mixture is stirred and sonicated for 3-6 min. As a result, a transparent colorless solution of micelles of NaBH4 (aq.) in iso-octane with AOT as surfactant is obtained. To the remaining solution of AOT in iso-octane in the first Schlenk tube are added 1.2 ml of a solution of 714 mg of CoCl₂.6H₂O (98%, ACS reagent, Aldrich) in 10 ml of distilled water. The mixture is stirred and sonicated (as above), producing a transparent pink solution of CoCl₂ (aq.) micelles in iso-octane with AOT as surfactant. Both solutions are cooled in an ice-acetone bath with stirring. The above-mentioned solution of NaBH₄ is quickly added to the solution of CoCl₂ under a strong flow of Ar with vigorous stirring and while cooling with the ice-acetone bath. The reaction mixture shows first signs of colloid formation (i.e. the solution turning grayish) within 15 seconds after addition with a significant black color developing within 20-25 seconds. At the peak of the reduction step noticeable amounts of H₂ evolve producing vigorous bubbling. Effective stirring is therefore required during this stage. The mixture is left under the flow of Ar for 5 more minutes in the ice-acetone bath. The use of the low temperature reduction step assists in the formation of nanoparticles of an appropriate size, since it discourages the formation of larger particles. The bath is then removed to allow a slow warming-up of the stirred reaction mixture to room temperature under the flow of Ar. This colloid solution contains significant amount of AOT surfactant, which has to be removed for a successful CNT growth.

The Co colloid is purified as follows. 60 ml of methanol (dry, freshly distilled under N₂) is added to the deep black cobalt colloid solution obtained as described above. The mixture is stirred, manually shaken and allowed to settle for several hours. An almost transparent top layer and an almost transparent bottom layer are syringed out and discarded. Methanol (dry, freshly distilled under N₂) is then added with stirring to the remaining viscous black flocculate (the volume of the added methanol determines the concentration of the purified colloid, typically 10-20 ml), to produce a deep black colloid solution. This “flocculation-purified” colloid can be used “as prepared” or can be filtered through a 0.2 μm PTFE syringe filter prior to use for growing carbon nanotubes. It is noted by the inventors that both “as synthesised” and “purified” cobalt colloid solutions deteriorate (by sintering, i.e. particle agglomeration) within 1-2 days, even when stored under argon or nitrogen to reduce or avoid oxidation in air.

It is known that plasma-enhanced chemical vapour deposition (PECVD) techniques can be used to grow aligned carbon nanotubes, the alignment being provided by the electrical field across the plasma sheath. Thus, it is possible grow nanosized patterns or even isolated free-standing nanotubes aligned using PECVD, as is described in detail below.

Organometallic or metal salt precursors require in situ decomposition to produce the metal catalyst nanoparticles for CNT growth. For example, the method of Kind et al (“Printing gel-like catalysts for the directed growth of multiwall nanotubes”, Langmuir 2000, 16, 6877-6883) uses a Fe(III) salt gel-like catalyst precursor ink, applied to a substrate from a patterned stamp. Controlling the decomposition to form the metal catalyst nanoparticles is cumbersome when a precursor is deposited in a nanosized pattern. A metallic colloid (e.g. Co colloid or NiPd colloid) contains pre-formed metal catalyst nanoparticles and hence it is an ideal candidate for acting as the ink for contact printing to produce nanosized patterned CNT arrays by PECVD. This is set out in Golovko et al (“Submicron patterning of Co colloid catalyst for growth of vertically aligned carbon nanotubes”, Nanotechnology 16 (2005) 1636-1640), the content of which is hereby incorporated in its entirety by reference.

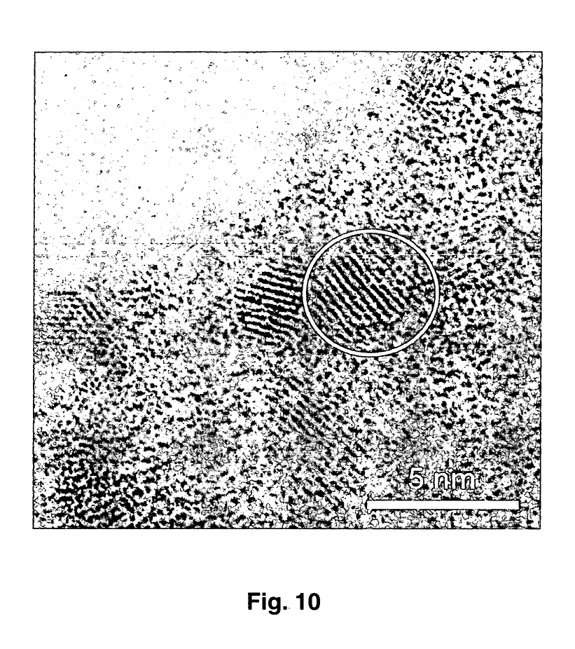

The Co colloid is produced using the method described above using the inverse micelle process with AOT as the stabilising agent. The Co nanoparticles have a particle size of 2-4 nm. The as-prepared colloid solution contains a large excess of surfactant (typically 6 g of surfactant is used in the preparation of colloid containing 23 mg of Co), which may inhibit the catalytic activity of the nanoparticles. Thus, the excess is removed by flocculating the colloid with methanol, as described above. The flocculated colloid is easily re-dispersed in methanol by stirring. A further purification and narrowing of the particle size distribution is achieved by filtration through a 0.2 μm PTFE syringe filter and centrifugation (14 000 rpm, 1-4 min). Care is taken to avoid contact of the colloid with air during this purification step to exclude oxidative decomposition. High resolution transmission electron microscopy (HRTEM, JEOL 3010, 300 kV) analysis confirms the presence of monodisperse crystalline Co nanoparticles with a size of 2-4 nm, as shown in FIG. 10, in which a Co nanoparticle is shown circled. The scale bar has a length of 5 nm.

The present inventors have found that it is possible to form patterns of cobalt colloid catalyst nanoparticles at the 100 nm scale by nanocontact printing over large areas to allow the growth of vertically aligned nanotubes by PECVD directly on the substrate surface. The use of the term “vertically-aligned” here assumes that the substrate is substantially horizontal. More generally, it is possible using the invention to grow carbon nanotubes substantially perpendicularly to a locally planar substrate surface.

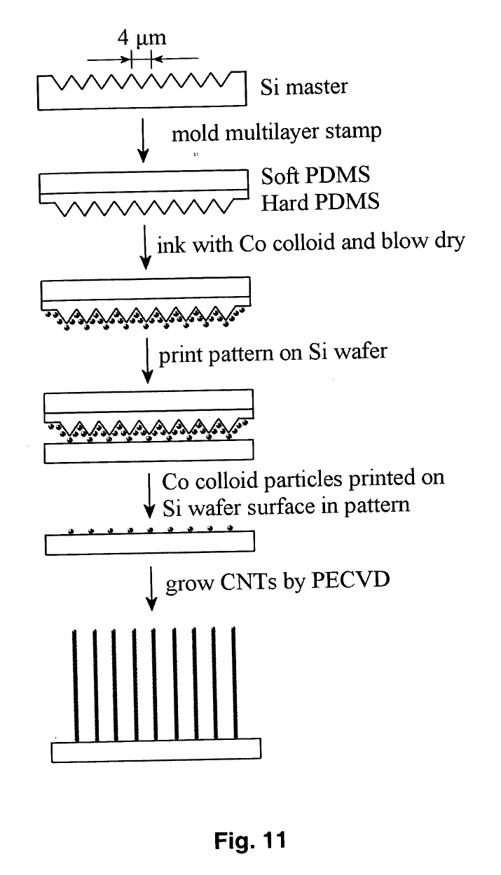

The nanocontact printing of a Co colloid into sub-400 nm features and subsequent PECVD growth are summarized in FIG. 11. V-shaped and pyramid-shaped silicone masters are fabricated by anisotropic etching with KOH_{aq} and are used to form line- and dot-patterned poly(dimethyl siloxane) (PDMS) stamps, respectively. A suitable technique for forming the master is disclosed in Xia, Y. and Whitesides, G. M. (“Shadowed sputtering of gold on V-shaped microtrenches etched in Si and applications in microfabrication”, Adv. Mater. 1996, 8, 765-768), the content of which is incorporated herein by reference in its entirety. The bottom ends of the V-shaped trenches have a width of less than 50 nm and hence provide a very low cost nanofabrication route. The stamp consists of a 30-50 μm thick film of hard PDMS to reproduce sub-50 nm features, and a 5-10 mm layer of soft PDMS in order to facilitate printing over a large area. Before each printing cycle, the stamp is sonicated in absolute ethanol, washed in water and blow-dried. A freshly prepared and purified concentrated solution of Co colloid is used as ink, which is deposited on the stamps and gently dried under N₂ flow. Silicon substrate wafers are cleaned with acetone, absolute ethanol, water and treated with a mild oxygen plasma. A dried stamp is placed on the surface of the cleaned silicon wafer, with care taken to ensure uniform contact between the surfaces and no horizontal displacement. The stamp mass of 0.5-1 g is usually sufficient to ensure contact during printing; however, additional pressure exerted by hand or a weight may also be used. The precise printing pressure and the amount of Co colloid deposited on the stamp during the inking process requires optimisation, otherwise some variation in pattern feature sizes is observed. The stamp is kept in contact with the silicon wafer for 5-30 s and then removed. The silicon wafers with printed patterns of Co colloid are kept under Ar atmosphere prior to PECVD deposition.

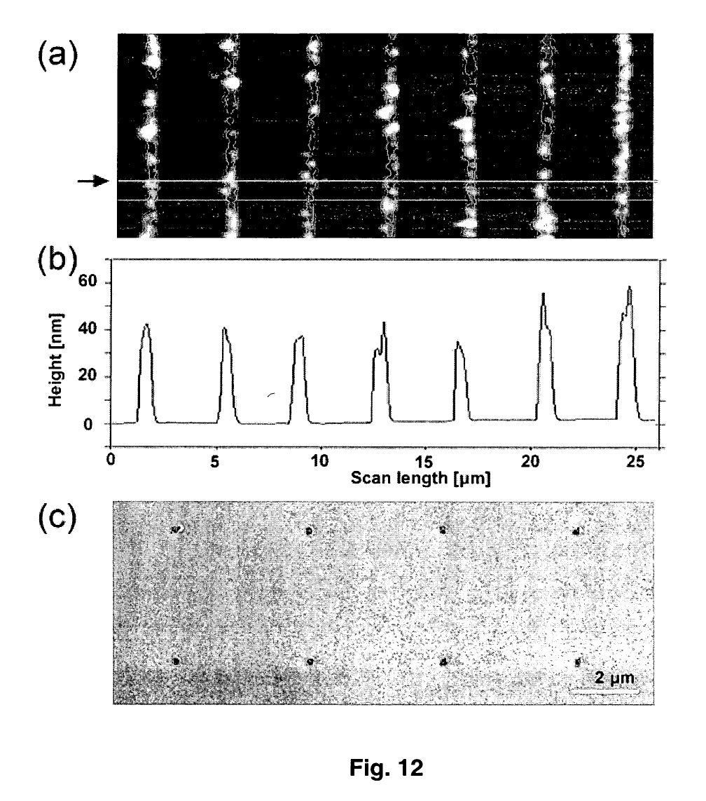

Patterns of cobalt colloid catalyst on the silicon wafer surface were studied by scanning electron microscopy (SEM, JEOL 6340 FEGSEM) and atomic force microscopy (AFM, tapping mode). Regular line and dot patterns such as in FIGS. 12(a) and (c) can be printed over large areas. Lines of 300 nm width and 30-60 nm height are typically observed as seen in FIG. 12(b). This indicates that a relatively large amount of colloid ink transfers from the stamp to the surface. Hence, the line width of the Co colloid patterns is considerably larger than that of the PDMS stamp. It is found that higher Co colloid loadings give better CNT growth for the case of non-patterned surfaces. Indeed, less transfer of catalyst ink leads to sparser CNT growth. The colloid loading used is a compromise between too little catalyst which can give a sparse growth, probably due to plasma etching of the catalyst, and too much colloid which can give too wide a pattern.

Aligned CNTs are then grown on the patterned substrate using a DC PECVD system in a stainless steel vacuum chamber with a base pressure below 10-6 mbar. Details of the PECVD process and the temperature control are given in Hofmann et al (2003 Appl. Phys. Lett. 83 135) and in Hofmann et al (2003 Appl. Phys. Lett. 83 4661), the contents of which documents are hereby incorporated by reference in their entirety. The samples are heated in a 0.6 mbar NH₃ atmosphere for 15 min to reach the desired temperature. The DC plasma discharge is then generated by applying 600 V between the sample holder (cathode) and a gas inlet (anode) located at about 2 cm above the sample holder. The acetylene feed gas, C₂H₂ (grade 1.5), is introduced via a separate mass flow controller. The C₂H₂:NH₃ ratio is kept constant at 50:200 sccm at a total pressure of 0.7 mbar and a discharge current was typically 30 mA, corresponding to a plasma power of less than 20 W.

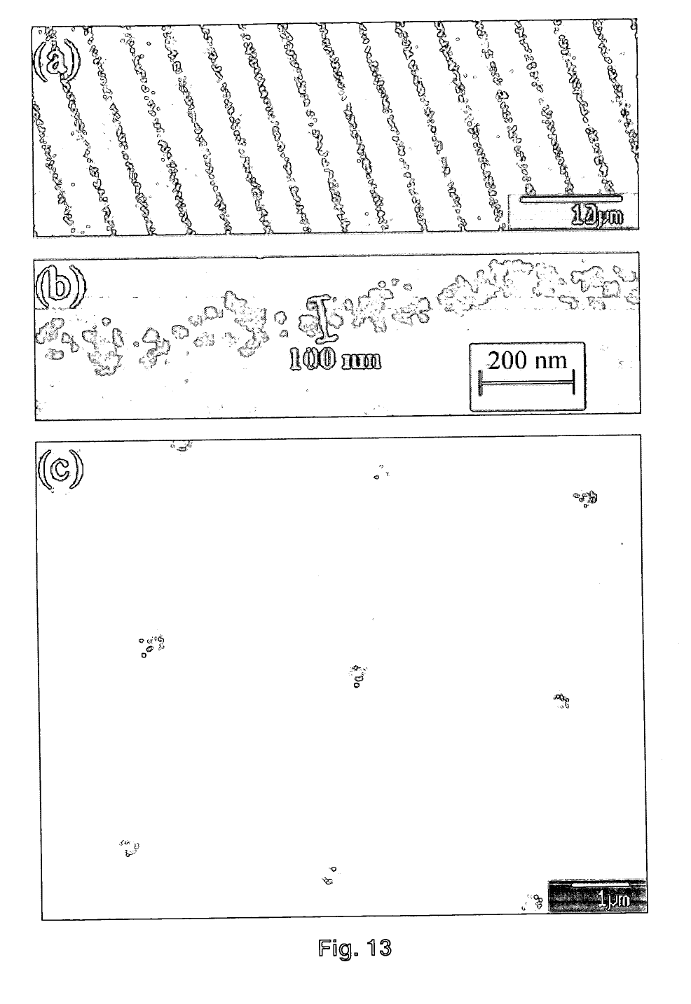

The nanotube patterns were examined by SEM (JEOL 6340 FEGSEM, LEO 1530VP FEGSEM). It is observed that thin, vertically aligned and similarly sized nanotubes grow directly on the surface. FIG. 13(a) shows an example of patterns of vertically aligned CNTs grown at 300° C. over a large area. FIG. 13(b) shows a top view SEM image of a thin line of the vertically aligned CNTs grown at 300° C. A top view of CNTs grown at 530° C. in a dot array is shown in FIG. 13(c). These images give a good indication of the resolution achievable by nanocontact printing. Each line consists of a narrow row of nanotubes, indicating that nanocontact printing could provide feature sizes small enough to create single, isolated nanotubes.

The linewidth is less than 100 nm in a good case (see FIG. 13(b)) with typical linewidths of 100-300 nm in other printing attempts with the same stamp. The decrease of linewidth indicates that the Co colloid has sintered into smaller islands during sample heating. This sintering or nanostructuring process was previously found to occur for sputtered Ni films (see Chhowalla et al(J. Appl. Phys. 90 5308)). This would explain the difficulty, previously, of growing nanotubes from very thin lines or small dots, where simply too little Co catalyst may be present.

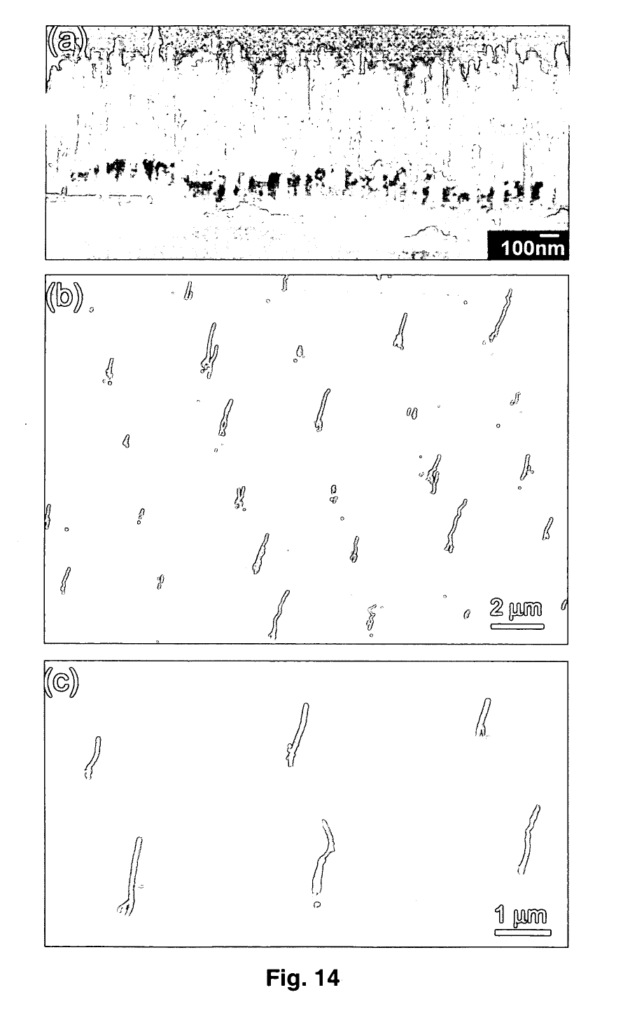

FIG. 14(a) shows a side view of line of carbon nanotubes. FIGS. 14(b) and (c) show perspective views of a dot pattern of CNTs grown at 640° C. FIGS. 14(b) and (c) show the quality and height of the nanotubes. The height of CNTs shown in FIG. 14(a) is 500-700 nm, indicating a growth rate of 0.7 nm s⁻¹ at this temperature (450° C.). In FIGS. 14(b) and (c) are shown SEM images of CNTs grown at 640° C. from the colloid printed in dot patterns. The printing is able to provide dots with about 150 nm diameter (FIG. 12(c)). FIGS. 14(b) and (c) show that in most cases a single nanotube grows from each dot due to colloidal particles sintering together at high temperatures. This shows that the printing is able to achieve a high resolution necessary for certain applications, such as display applications.

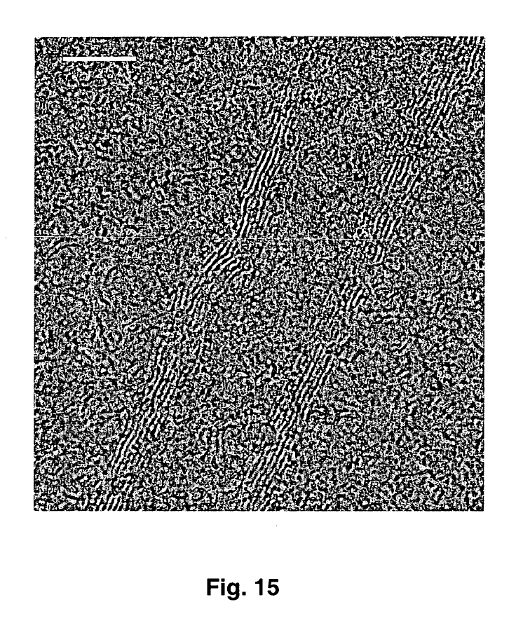

The internal structure (FIG. 15) of CNTs grown has been studied by HRTEM using a JEOL 3010 (300 kV). This image shows that the nanotubes have reasonably parallel and continuous side walls. The tips are usually found to contain Co catalyst particles, confirming the tip growth mechanism. The metal particles in the CNT tips are larger than the original Co colloid nanoparticles. This indicates that a sintering of the Co colloid occurs prior to CNT growth. CNT growth at 450-550° C. tends to give better CNT quality and with more bamboo-like structure compared to the CNTs grown at lower (300° C.) temperatures, which have structures closer to herringbone type.

A comparison of SEM and TEM images shown in FIGS. 14 and 15 reveals that the quality of the nanotubes shown there is slightly better than that of those grown at a similar temperature from a Ni thin film catalyst (Hofmann et al (2003 Appl. Phys. Lett. 83 135)). The smaller nanotube diameters and narrower nanotube diameter distribution found here indicate a better control of the catalyst particle size. Indeed, thermal CVD growth using analogous Co colloid catalyst produces CNTs with very similar diameters (Ago et al (Applied Physics Letters Vol. 82, No. 5 (2003) 811-813)). A smaller diameter and better control of diameter and diameter distribution is considered to be important for field emission applications.

Using the procedures set out above, it is possible to print high resolution patterns of Co colloid ink onto a substrate using nanocontact printing techniques. Of importance is the ability to create the ink having a high concentration of nanoparticles to ensure that a suitable number of particles is deposited in the printed pattern. However, Co nanoparticles are not stable and tend to oxidise in air. They cannot be stored for long periods at room temperature. Therefore it is preferred to use instead nanoparticles formed from at least a transition metal and a noble metal, e.g. Ni—Pd nanoparticles as described above. Such nanoparticles have similar catalytic activity for the formation of carbon nanotubes. Thus, an ink of such multimetallic nanoparticles is formed using the techniques set out above. Such an ink has a narrow and stable particle size distribution. Also, the ink can be stored for long periods of time since it is resistant to oxidation. Immediately after production, or after storage, the ink can be printed using the nanocontact techniques set out above. The ink can be formed at an appropriate concentration in a carrier such as methanol as desired. The as-printed substrate can be stored in the same way that the colloid can be stored, due to the resistance to oxidation of the nanoparticles. Carbon nanotubes are grown using PECVD as described above, to form an array of aligned carbon nanotubes upstanding from the substrate.

In an as-made colloid of Ni—Pd, as described above, there tends to be used an excess of PVP as the stabilizing agent. It is considered that this excess of PVP may hamper catalytic activity. Accordingly, the excess PVP is removed using the technique described above to flocculate the colloid using acetone and then re-dispersing the colloid using methanol, at the required concentration for the deposition technique to be used.

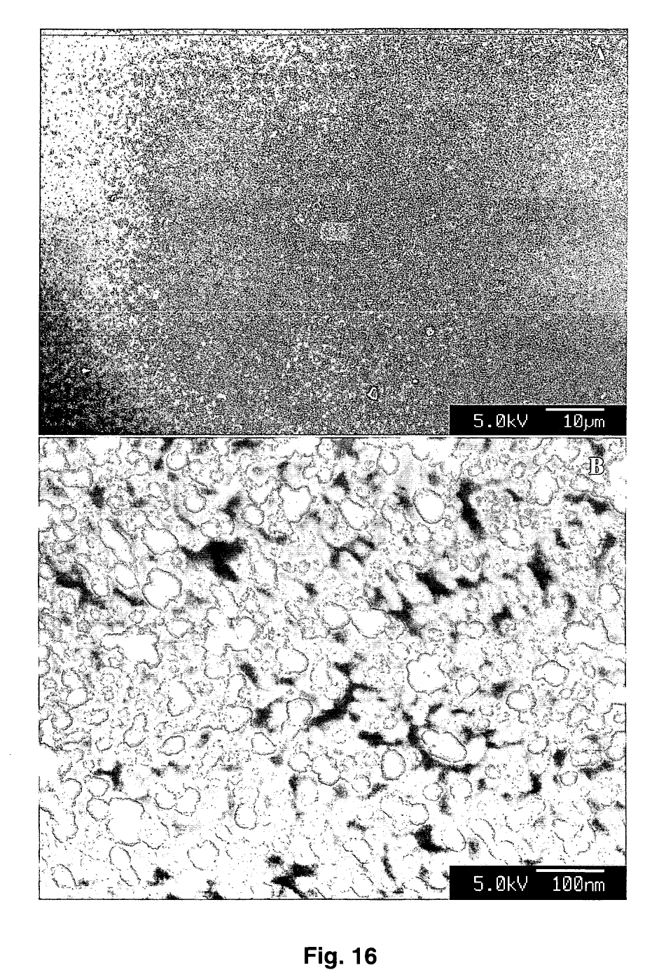

FIG. 16 shows SEM images (in plan view) of carbon nanotubes grown on a substrate surface using Ni—Pd nanoparticles prepared as described above. FIG. 16A is a low magnification image. FIG. 16B is a high magnification image showing a dense carbon nanotube “forest”, and showing that the metal nanoparticles sit in the carbon nanotube tips.

Alternate deposition techniques for forming suitable patterns of nanoparticles on a substrate are also contemplated. For example, inkjet printing techniques may be used. The advantage of using a stable colloid ink in an inkjet printer is that the ink is stable and so can be stored for suitable periods of time and the deposition can take place in air, which facilitates deposition on large area substrates.

The embodiments of the present invention have been described by way of example. Modifications of these embodiments, further embodiments and modifications thereof will be apparent to the skilled person on reading this disclosure and are therefore within the spirit and scope of the present invention.

1. A method for producing a colloid of metallic nanoparticles including the steps of:
providing metal ions in solution;
providing a stabilizing agent; and
reducing said metal ions in the presence of said stabilizing agent, so that metallic nanoparticles are formed with a surrounding layer of said stabilizing agent,
wherein the reduction step is carried out at a temperature of not less than 20° C. and not more than 150° C.

2. The method of claim 1 wherein the reduction step is carried out at a temperature of not less than 50° C.

3. The method of claim 1 wherein the reduction step is carried out at a temperature of not less than 75° C.

4. The method of claim 1 wherein the reduction step is carried out at a temperature of not more than 140° C.

5. The method of claim 1, wherein the average particle size of the metallic nanoparticles is between 1 nm and 6 nm.

6. The method of claim 5, wherein the standard deviation of the particle size of the metallic nanoparticles is 2 nm or less.

7. The method of claim 1 wherein the metallic nanoparticles are multimetallic nanoparticles.

8. The method of claim 7 wherein each metallic nanoparticle includes at least one first row transition metal and at least one noble metal.

9. The method of claim 1, wherein the metallic nanoparticles are formed from at least one metal selected from palladium, nickel, iron and cobalt.

10. The method of claim 1, wherein the metallic nanoparticles are Ni—Pd bimetallic particles.

11. The method of claim 10, wherein the Ni—Pd metallic nanoparticles have a molar ratio of Ni:Pd of 1:1 or less.

12. The method of claim 11, wherein the Ni—Pd metallic nanoparticles have a molar ratio of Ni:Pd of 1:2 or less.

13. The method of claim 1, wherein the reduction of the metal ions is carried out in a polyol.

14. The method of claim 13, further including the steps of adding excess ketone to flocculate the nanoparticles, thereby removing excess of the stabilizing agent from the nanoparticles, and removing a resultant supernatant liquid phase.

15. The method of claim 14, further including the step of adding an alcohol after removal of the mixture of the supernatant liquid phase, in order to re-disperse the nanoparticles.

16. The method of claim 13, wherein the reduction of the metal ions is carried out below the boiling point of a reducing agent used in the method.

17. The method of claim 1, wherein the stabilizing agent is a polymer, molecules of said polymer interacting with the surfaces of said nanoparticles by adsorption.

18. The method of claim 1, wherein the stabilizing agent is a surfactant.

19. A method for producing a colloid of metallic nanoparticles including the steps of:
providing transition metal ions in solution;
providing noble metal ions in solution;
providing a stabilizing agent polymer; and
reducing said metal ions in the presence of said stabilizing agent, so that metallic nanoparticles are formed of a mixture of transition metal atoms and noble metal atoms with a surrounding layer of said stabilizing agent polymer,
wherein the reduction step is carried out at a temperature of not less than 80° C. and not more than 150° C.

20. A patterned array of carbon nanotubes or nanofibers on a substrate, wherein metallic nanoparticles are disposed at an extremity of said nanotubes, said metallic nanoparticles being formed of a mixture of a transition metal and a noble metal.

21. The array of claim 20, wherein the metallic nanoparticles are disposed at the tips of said nanotubes or nanofibers.

22. The array of claim 20, wherein the metallic nanoparticles are Ni—Pd metallic nanoparticles have a molar ratio of Ni:Pd of 1:1 or less.

23. The array of claim 20, wherein the metallic nanoparticles are Ni—Pd metallic nanoparticles have a molar ratio of Ni:Pd of 1:2 or less.

24. The array of claim 20, wherein the carbon nanotubes or nanofibers are aligned upstanding from the substrate.

25. The array of claim 24, wherein the array is patterned so that gaps of at least twice the height of the carbon nanotubes or nanofibers are formed between adjacent nanotubes or nanofibers or groups of nanotubes or nanofibers.

26. An array of carbon nanotubes on a substrate, wherein metallic nanoparticles are disposed at an extremity of said nanotubes, said metallic nanoparticles being formed of Ni—Pd, the carbon nanotubes being aligned upstanding from the substrate and being bonded to the substrate, and wherein the array is patterned so that gaps of at least twice the height of the carbon nanotubes are formed between adjacent nanotubes or groups of nanotubes.

27. A method of producing an array of carbon nanotubes on a substrate including the steps:
applying nanoparticles onto the substrate said nanoparticles being formed of a mixture of a transition metal and a noble metal growing carbon nanotubes via chemical vapour deposition, in which growth the nanoparticles act as catalysts.

28. The method of claim 27, wherein the substrate is selected from: a flat substrate and a three-dimensional porous substrate.

29. The method of claim 27, wherein the chemical vapour deposition is plasma-enhanced chemical vapour deposition.

30. The method of claim 27, wherein the nanoparticles applied to the substrate have a surrounding layer of stabilizing agent, in order to reduce agglomeration of the nanoparticles.

31. The method of claim 30, wherein the stabilizing agent is a polymer, molecules of said polymer interacting with the surfaces of said nanoparticles by adsorption, and wherein the metallic nanoparticles are Ni—Pd nanoparticles.

32. A method of producing an array of carbon nanotubes on a substrate including the steps:
applying metallic nanoparticles onto a profiled surface of a tool;
applying a pattern of metallic nanoparticles onto the substrate by contacting the substrate with the profiled surface of said tool; and
growing carbon nanotubes via chemical vapour deposition, in which growth the metallic nanoparticles act as catalysts,
wherein at least one feature of said pattern has a dimension of 500 nm or less.

33. The method of claim 32, wherein the profiled surface of the tool has at least one projecting feature with a dimension of 100 nm or less.

34. The method of claim 32, wherein the profiled surface of said tool is formed from a layer of a first material, and said layer of first material is formed on a carrier of a second material, said first material being harder than said second material.

35. The method of claim 32 wherein said metallic nanoparticles are applied to said tool as a colloidal suspension of nanoparticles in a carrier liquid, said nanoparticles being formed with a surrounding layer of a stabilizing agent.

36. The method of claim 35 wherein the metallic nanoparticles are formed from a mixture of a transition metal and a noble metal.

37. The method of claim 32, wherein the metallic nanoparticles are formed from at least one metal selected from palladium, nickel, iron and cobalt.

38. The method of claim 32, wherein the metallic nanoparticles are Ni—Pd bimetallic particles.

39. The method of claim 38, wherein the Ni—Pd metallic nanoparticles have a molar ratio of Ni:Pd of 1:1 or less.

40. The method of claim 38, wherein the Ni—Pd metallic nanoparticles have a molar ratio of Ni:Pd of 1:2 or less.
